(19) United States
(12) Patent Application Publication
(10) Pub. No.: US 2012/0280528 A1
(43) Pub. Date: Nov. 8, 2012

(54) VEHICLE ACCENT MOLDING WITH PUDDLE LIGHT

(75) Inventors: Paul K. Dellock, Northville, MI (US); Gregory J. Grudzinski, Perrysburg, OH (US); Michael Musleh, Canton, MI (US); Joel T. Pierce, Whitmore Lake, MI (US); Charles A. Azzouz, Novi, MI (US)

(73) Assignee: FORD GLOBAL TECHNOLOGIES, LLC, Dearborn, MI (US)

(21) Appl. No.: 13/102,319

(22) Filed: May 6, 2011

(51) Int. Cl. B60R 13/02; F21V 7/00

(52) U.S. Cl. 296/1.08; 362/516

(57) ABSTRACT

A trim molding for an exterior surface of a vehicle is provided with a trim body formed of a light transmissive material for coupling to the exterior surface, the trim body having an interior side and an exterior side. A variable light source is disposed on the interior side of the trim body. A one-way mirror is disposed on the exterior side of the trim body having an opaque appearance from outside the trim molding in bright ambient lighting conditions. The one-way mirror transmits light from the variable light source therethrough. The variable light source provides a first lighting level for accenting the exterior surface of the vehicle in dark ambient lighting conditions. The variable light source provides a second lighting level greater than the first lighting level to illuminate the ground near the vehicle to assist in vehicle entry in dark ambient lighting conditions.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

is The present invention relates in general to exterior lighting of a motor vehicle for entry illumination and for accenting the vehicle styling, and, more specifically, to an illuminated trim molding positioned to act as a puddle light.

Supplemental exterior lighting on motor vehicles (i.e., other than the headlamps and tail lamps) serves several important purposes. They provide an indicator to signal the location of the vehicle sides in order to enhance visibility of the vehicle to others. They can provide attractive styling accents to the vehicle in both their lit and unlit states. They also provide illumination to the area around the vehicle when the passengers are entering or approaching the vehicle under dark conditions. When directed downward toward the ground, such lamps are known as puddle lamps.

A typical puddle lamp comprises a light source in a housing with a clear cover or lens which is mounted to an underside of a vehicle body or a side view mirror. When activated, the light shines on the ground illuminating the area around the entry doors or trunk to assist the user in entering.

### SUMMARY OF THE INVENTION

The present invention enhances the styling of puddle lamps and combines the functions of low brightness accent lighting with high brightness entry lighting. In daylight or bright ambient light, the puddle lamp has the appearance of a normal trim molding, thereby achieving improved daytime styling appearance as well. In particular, the invention uses a “one-way mirror” element that allows light emerging from the trim to be seen in dark conditions while preventing the interior of the trim to be seen in daylight conditions. As used herein, the term one-way mirror includes films, laminates, coatings, or any other structures within a trim molding that provide a one-way mirror function. The term further includes any daylight surface appearance such as reflective, non-reflective, chrome-like, any level of gloss, flat, painted, or tinted with any colors.

In one aspect of the invention, a trim molding for an exterior surface of a vehicle is provided with a trim body formed of a light transmissive material for coupling to the exterior surface, the trim body having an interior side and an exterior side. A variable light source is disposed on the interior side of the trim body. A one-way mirror is disposed on the exterior side of the trim body having an opaque appearance from outside the trim molding in bright ambient lighting conditions. The one-way mirror transmits light from the variable light source therethrough. The variable light source provides a first lighting level for accenting the exterior surface of the vehicle in dark ambient lighting conditions. The variable light source provides a second lighting level greater than the first lighting level to illuminate the ground near the vehicle to assist in vehicle entry in dark ambient lighting conditions.

### BRIEF DESCRIPTION OF THE DRAWINGS

FIG. 1 is a perspective view of a vehicle having the illuminating trim molding of the present invention.

FIG. 2 is a perspective view of a side-view mirror having the illuminating trim molding of the present invention.

FIG. 3 is an exploded, perspective view of a trim molding according to one preferred embodiment.

FIG. 4 is a cross section of a laminated film providing a one-way mirror effect.

FIG. 5 is a partial plan view of a light guide in the form of a ring.

FIG. 6 is a cross section of a section of a light guide.

FIG. 7 is a cross section through a trim molding assembly according to a further embodiment of the invention taken along line 7-7 in FIG. 8.

FIG. 8 is a partial front view of the assembly of FIG. 7.

FIG. 9 is a partial cross-sectional, perspective view of a trim molding assembly connected to an electrical driver.

FIG. 10 is a plan view of a simplified light guide for uniform illumination.

FIG. 11 is a plan view of a shaped light guide for providing a pattern for the light transmitted from the molding.

### DETAILED DESCRIPTION OF PREFERRED EMBODIMENTS

The exterior vehicular lighting device of the present invention comprises a back-lit molding that appears to be chrome or a tinted surface in daylight (i.e., bright/ambient lighting conditions) that can be lit in a manor that the light shines through the chrome/tinted surface under dark ambient lighting conditions. The interior light source provides two levels of brightness. The first is low level brightness for a soft glowing light that illuminates the molding for accent and side-marking purposes, and the second is a high level puddle light setting that lights the ground beside the vehicle.

The trim molding includes a molded light guide or pipe which may be injection molded and is either attached to or integrally molded with a trim body or base for transporting and distributing light across the length of the molding or to desired locations along the molding. A one-way mirror such as a reflective film is disposed on the outside of the trim body (and may be covered by an outer protective layer). The film provides a metallic, chrome-like, or tinted reflective surface on the visible side of the molding that prevents the interior of the molding from being seen in daylight but that is sufficiently transparent to light exiting the molding under dark conditions to achieve the desired illumination. The film can be affixed to the trim body with an adhesive or the film can be inserted into the mold tool for making the light guide/trim body prior to injecting the plastic, thereby mating the film to the trim molding. A clear outer protective layer may be applied over the film by molding, painting, or other known methods for protecting vehicle trim.

One or more light sources such as light emitting diodes (LEDs) are placed at the ends or at various positions along the light guide. The light guide with the light sources forms a light bar. The LEDs are operated in either a low power mode or a high power mode. While the LEDs are in the low power mode or normal mode, the light bar emits a soft glowing ambient light through the two-way reflective film. Normal mode may be activated when either the vehicles head lamp, park lamp, and/or fog lamps are powered on. In high power mode, the light bar is brightly lit illuminating the ground around the vehicle, e.g., at the side entry doors or trunk. This puddle lamp function may be activated when a vehicle door or trunk is unlocked by use of a key and/or use of a wireless key FOB.

The back side of the light pipe may be treated to prevent/reduce light pass through. This can be done by several methods including painting the back side of light pipe, application of an opaque tape, molding a frosted back surface or two-shot molding of an opaque rear surface. A reflective back plate may also be provided in the molding to make efficient use of all the light emitted.

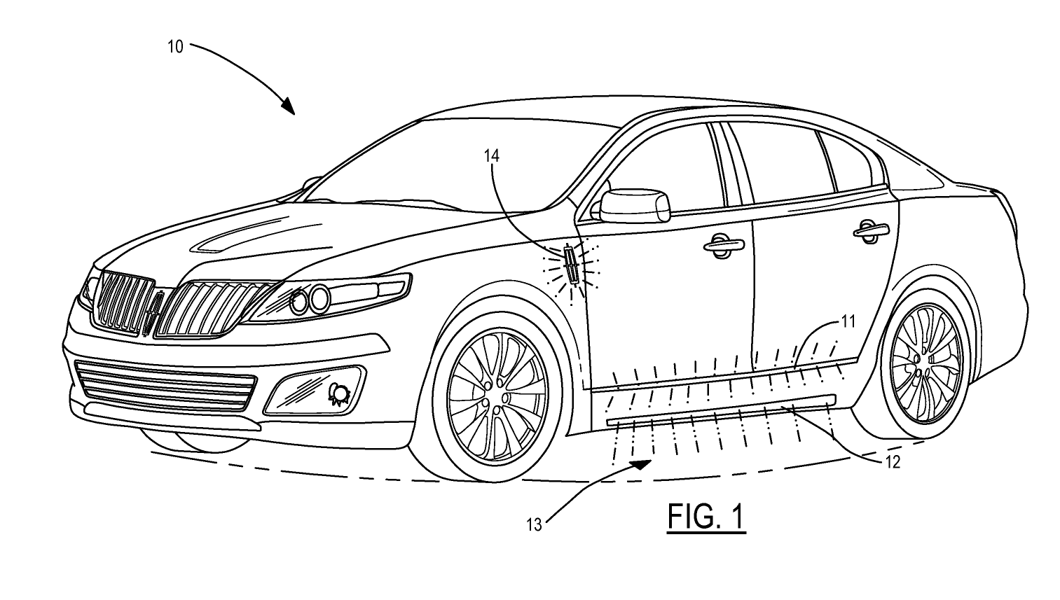

Referring now to FIG. 1, a vehicle 10 has a pair of molding strips 11 and 12 each mounted to a side of the vehicle below the side passenger doors. In this position, light from trim molding strips 11 and 12 can be directed downward to illuminate the ground 13. In addition, a percentage of light is also directed upward and sideways to provide an attractive accent marking as well as a side marking function. Under bright ambient light conditions, molding strips 11 and 12 appear opaque to an outside observer and thus appear to be a conventional molding without any lighting function. The strips may also include words, emblems, or designs with a contrasting color or brightness that may be visible in daylight or may only become visible when illuminated. When acting as a puddle light, the words, emblems, or designs may be placed in a manner to be seen in projection on ground 13.

In addition to a strip shape, the invention can use any arbitrarily shaped trim piece such as an emblem 14. Emblem 14 may be positioned to illuminate more of the surroundings of vehicle 10 than just the ground 13.

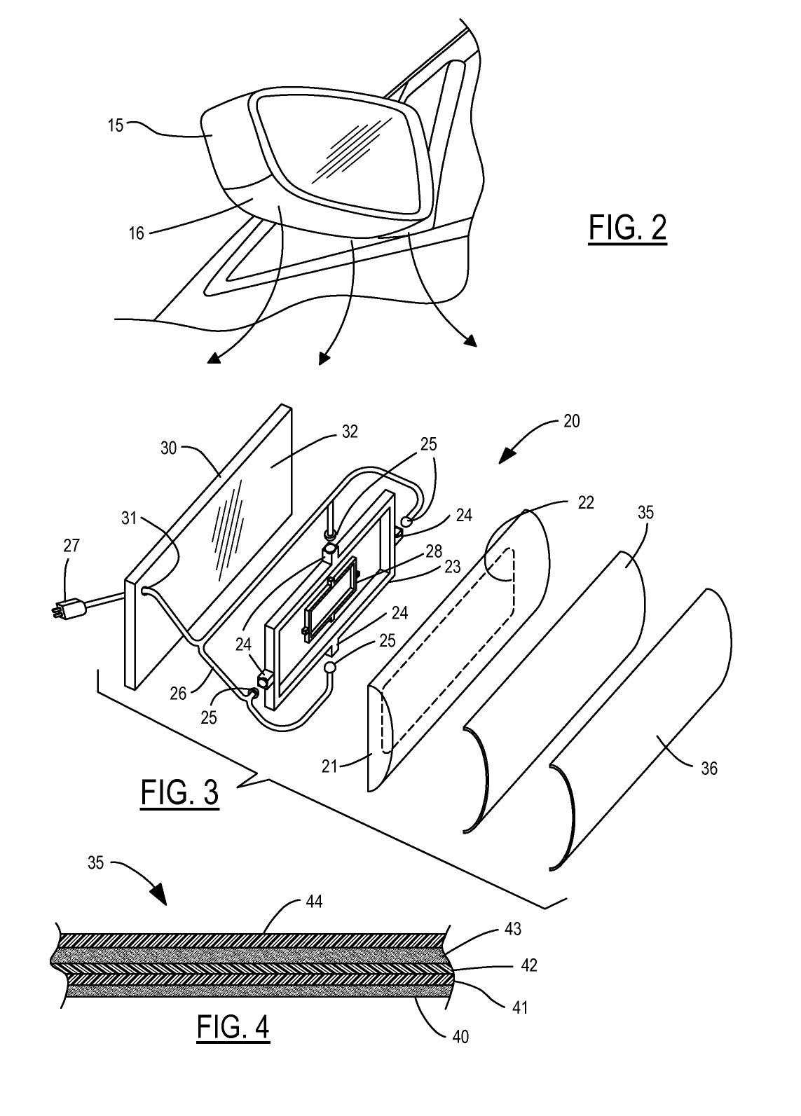

FIG. 2 illustrates a side view mirror housing 15 having a trim molding 16 disposed along the bottom side of housing 15. Light may be directed downward toward the ground from a majority of molding 16, while a portion of trim molding 16 may extend over a side of housing 15 in order to provide some sideways directed light for accent and marking purposes. Trim molding 16 may also include integral words, emblems, or designs.

FIG. 3 shows an exploded view of a trim molding 20 expressly showing all the desired functions of the present invention but including some specific components that provide a function that can be integrated with other components and thus would not be present in all embodiments. A trim body 21 is formed of a light-transmissive material such as a clear injection molded plastic. A recess 22 on an interior side of trim body 21 receives a light guide 23. Alternatively, light guide 23 can be integrally molded with trim body 21 as a single unitary part. Light guide 23 includes fixtures 24 for receiving a plurality of LEDs 25. Wiring 26 connects the plurality of LEDs 25 to a connector 27, which may be connected to a wiring harness of the vehicle (now shown). A back plate 30 attaches to trim body 21, e.g., by adhesive or other fastening means. Back plate 30 may have an aperture 31 to allow wiring 26 to exit the trim molding. Back plate 30 has a reflective surface 32 which may be provided by a metallization layer, a film, paint, or other coatings. A secondary light guide 28 with separate light sources can also be provided in order to achieve additional lighting effects or features.

Disposed on the exterior side of trim body 21 is a one-way mirror 35 that has an opaque appearance from outside the trim molding in bright ambient lighting conditions but that otherwise transmits light internally directed to it from light guide 23. Thus, the internal components are not seen under bright outside light. With the internal light sources turned on under dark outside conditions, the visibility of the internal components is under control of the designer and may include the shape of the light guide if desired or the internal components may not be apparent if trim body 21 or other elements provide diffusion of the light.

LEDs 25 are operated as a variable light source to provide a first lighting level for accenting the exterior surface of the vehicle in dark ambient lighting conditions. The LEDs are operated at a second lighting level greater than the first lighting level to illuminate the ground near the vehicle to assist in vehicle entry in dark ambient lighting conditions. The variable lighting levels can be achieved by turning on only a sub-group of LEDs for the first lighting level while activating all the LEDs to provide the second lighting level, or the LEDs may receive a variable drive signal that produces a light output proportional to the drive signal. The LEDs can have various colors as desired.

One-way mirror 35 may preferably be comprised of a laminated film of a type sold as a one-way mirror film for windows and other surfaces, such as Silver™ window film from Sun Tek of Martinsville, Va., or LLumar Reflective Window Films available from Solutia, Inc., of St. Louis, Mo. Alternatively, one-way mirror 35 can be a partially-reflective coating directly applied to the exterior side of trim body 21 by sputtering of a metal, such as silver, onto its outside surface. If a coating is applied to trim body 21 or if a one-way mirror film is used that does not include an outer scratch resistant layer, then a protective layer 36 may be applied over one-way mirror 35. Protective layer 36 may be a clear coat of a type conventionally used with automotive trim components.

FIG. 4 shows a cross section of a laminated film 35 with a protective layer in greater detail. An adhesive layer 40 is provided for attaching film 35 to the trim body. The adhesive may be supplied as part of a film product, and may be heat activated. A removable release liner (not shown) that may be with the film from the manufacturer is removed from adhesive layer 40 prior to application to the trim body. A polyester film layer 41 may optionally be provided if a colored or tinted appearance is desired for the trim molding (or may be an ultraviolet blocking layer in a conventional film made for window applications). Layer 41 may incorporate dies as is known in films for architectural glass. Layer 42 can be a metalized (e.g., sputtered) polyester film (or other materials known in the art) which achieves the one-way mirror effect. A further adhesive layer 43 attaches a scratch resistant coating layer 44. The film shown in FIG. 4 would potentially eliminate the need for a separate protective is layer 36.

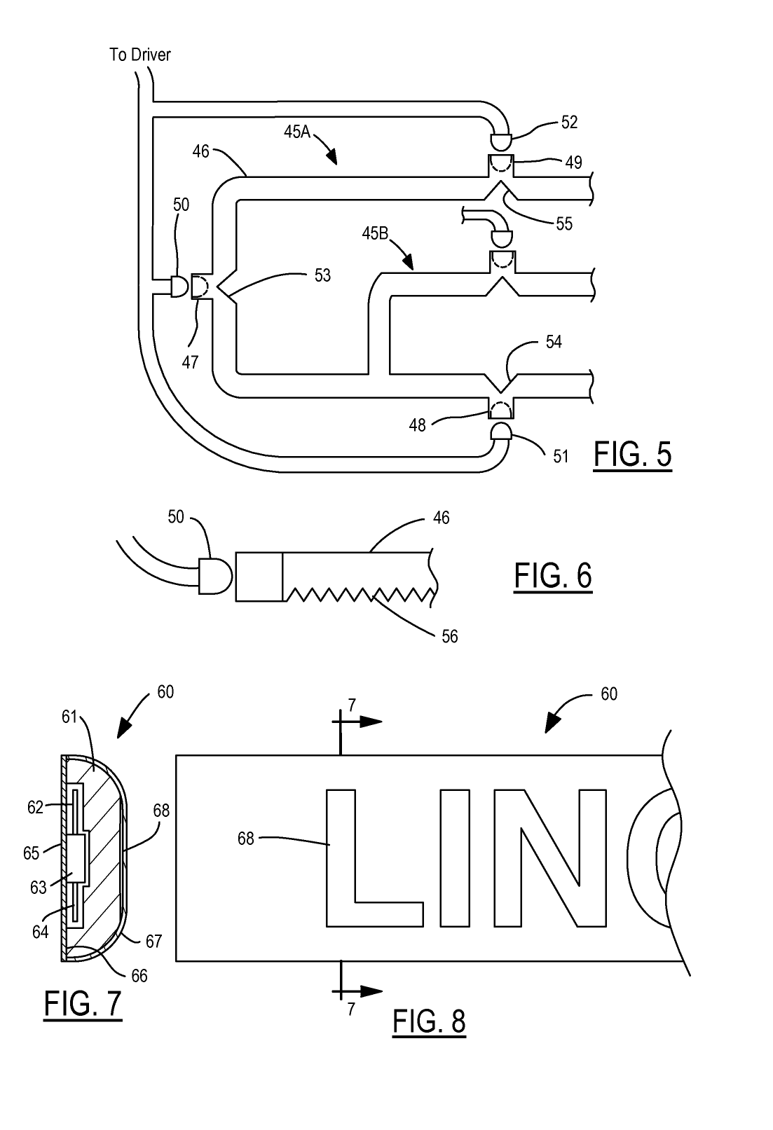

A more detailed view of a light guide 45A is shown in FIG. 5. A clear plastic ring 46 includes mounting blocks 47- 49 around the periphery of ring 46 for receiving LEDs 50-52, respectively. A separate light guide branch 45B may be included for obtaining a desired light distribution or other effects. In order to direct light from the LEDs throughout ring 46, angled surfaces or notches 53-55 are provided for deflecting light from the LEDs. Notches 53-55 may include a metalized (or reflective film) surface to increase reflection. Once the light enters ring 46, it may be controllably diffused through the trim body and out through the one-way mirror. As shown in the cross-section of FIG. 6, light ring 46 may have a treated backside 56 that reflects light out the front surface of ring 46. In addition to the sawtooth reflective surface shown, other surface treatments such as a frosted or stippled surface texture, painting or application of tapes or a metallization can be used on various surfaces of light guide 46 in order to pattern the field of light that is projected outward from the trim molding. Such patterning can be constant pattern or can be a changing pattern by differentially controlling the individual light sources in a time sequence. For example, the letters of a word could be turned on one after the other.

FIGS. 7 and 8 show an example that includes illuminated letters, logos, or other symbols. A trim molding 60 includes a trim body 61 comprised of a solid body of a molded thermoplastic. Trim body 61 could include differently colored regions, such as could be obtained using a multi-shot molding process. A recess 62 is formed in the interior side of body 61 for receiving an LED light bar 63 coupled to an acrylic light ring 64. LEDs in light bar 63 are arranged to direct light into ring 64 which distributes the light along the length of trim body 61. A back plate 65 has a front reflective surface 66 which may include a metallization layer or film.

Secured to the front side of trim body 61 is a one-way mirror element 67 of the type described above. In order to create contrasting light regions, a paint or other masking material 68 is applied to either an inner surface of one-way mirror 67 or an outer surface of trim body 61. As shown in FIG. 8, the masked area corresponds to a letter “L” that is seen under dark conditions when the puddle lamp or accent light features are activated. By inverting the paint application areas, the background could be dark, and the letters be illuminated.

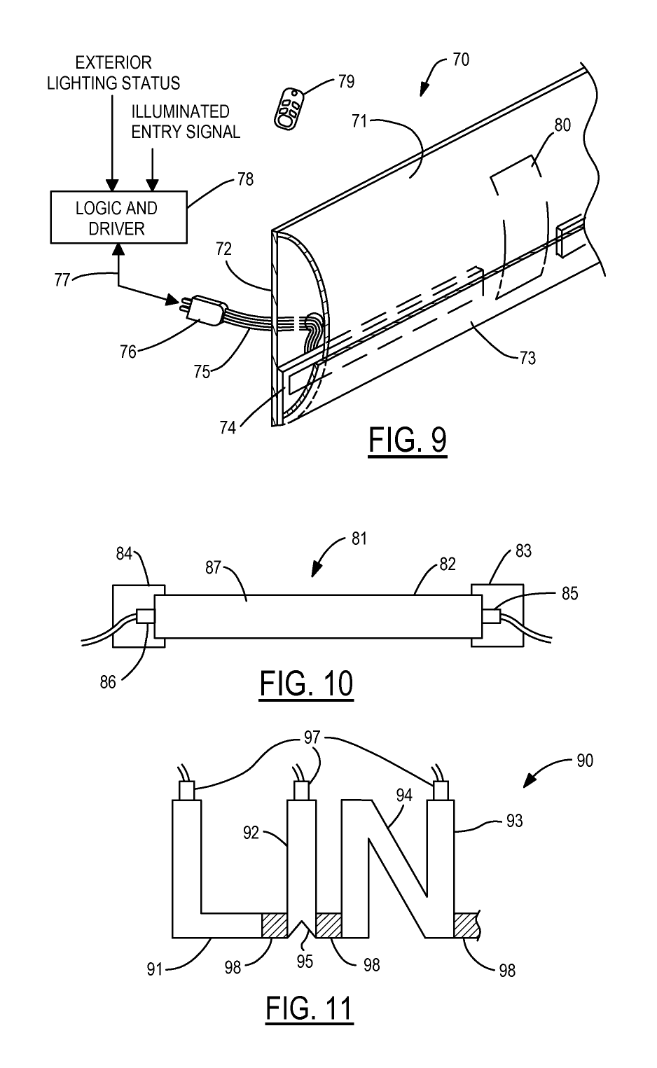

FIG. 9 shows a further embodiment of a trim molding 70 with a puddle lamp feature. A main body 71 is joined with a backing plate 72, and is covered by a laminated one-way mirror film 73. Between trim body 71 and back plate 72, a light guide 74 is mounted at the lower end in order to project most of its light downward toward the ground for operating as a puddle lamp. An emblem 80 or other features can be included for being lit together with or separately from a light bar, for being unlit, or for making a projection image onto the ground, for example. Wiring 75 passes through back plate 72 to connect with LEDs (not shown). A wiring connector 76 joins wires 75 to a wiring harness 77 and to a controller 78.

Controller 78 performs logic and driver functions to achieve the desired lighting properties. Controller 78 receives an illuminated entry signal from a vehicle's body module or remote entry module (not shown). The illuminated entry signal may be initiated when a vehicle user presses an unlock button on a wireless remote key fob 79, for example. In response to the illuminated entry signal, controller 78 drives the LEDs to provide a high lighting level to illuminate the ground near the vehicle to assist in vehicle entry in dark ambient lighting conditions. The high brightness level can be achieved by operating all LEDs in the unit or by driving them at a voltage sufficient to create the desired level of brightness.

Controller 78 also receives an exterior lighting status signal from a vehicle body module or an instrument panel module (not shown) responsive to driver-operated switches and/or other vehicle conditions. The exterior lighting status signal is indicative of the use of accent lighting. In response to the request for accent lighting, controller 78 drives the LEDs in a manner to activate them at a lower lighting level which can be achieved by driving a subset of all the LEDs or by driving the LEDs at a reduced voltage. For a more visually pleasing performance, controller 78 may gradually ramp the light output up to or down from each desired lighting level by ramping the magnitude of the drive signal or by ramping the number of LEDs being activated.

FIG. 10 shows a further embodiment wherein a trim molding 81 has a trim body 82 that integrally contains a light guide in the shape of a rod (or an emblem or any other shape). Trim body 82 includes mounting blocks 83 and 84 for mounting to the vehicle. A variable light source comprised of LEDs 85 and 86 are connected to a controller (not shown). A one-way mirror 87 covers trim body 82 as previously described. Trim molding 81 is adapted to provide a uniform distribution of light.

FIG. 11 shows an alternative light guide adapted to generate a patterned distribution of light. Thus, a light guide 90 includes various branches such as 91, 92, 93, and 94, and various reflective corners such as 95. Various LEDs 97 are coupled to respective branches in order to inject light that is then distributed to all the branches. In order to provide gaps between various symbols in the pattern produced, masked areas 98 may also be provided.

What is claimed is:

1. A trim molding for an exterior surface of a vehicle, comprising:
a trim body formed of a light transmissive material for coupling to the exterior surface, the trim body having an interior side and an exterior side;
a variable light source disposed on the interior side of the trim body; and
a one-way mirror disposed on the exterior side of the trim body having an opaque appearance from outside the trim molding in bright ambient lighting conditions, wherein the one-way mirror transmits light from the variable light source therethrough;
the variable light source providing a first lighting level for accenting the exterior surface of the vehicle in dark ambient lighting conditions; and
the variable light source providing a second lighting level greater than the first lighting level to illuminate the ground near the vehicle to assist in vehicle entry in dark ambient lighting conditions.

2. The trim molding of claim 1 wherein the light source is comprised of a plurality of light elements coupled to a transparent light guide for distributing the light onto the one-way mirror.

3. The trim molding of claim 2 wherein the light elements are comprised of LEDs.

4. The trim molding of claim 2 wherein the distribution of light upon the one-way mirror is substantially uniform.

5. The trim molding of claim 2 wherein the distribution of light transmitted from the trim molding has a pattern.

6. The trim molding of claim 5 comprising a painted surface corresponding to the pattern.

7. The trim molding of claim 2 wherein a subset of the light elements remain off to provide the first lighting level.

8. The trim molding of claim 2 wherein the light elements receive a drive signal and produce a light output proportional to the drive signal.

9. The trim molding of claim 1 wherein the one-way mirror is comprised of a laminated film that includes at least one layer of a metalized polyester film and an adhesive layer for fixing the laminated film to the trim body.

10. The trim molding of claim 9 wherein the laminated film further is comprises a dyed polyester layer.

11. The trim molding of claim 1 wherein the one-way mirror is comprised of a partially-reflective coating applied to the exterior side of the trim body.

12. The trim molding of claim 1 further comprising a protective clear coat over the one-way mirror.

13. The trim molding of claim 1 further comprising a reflective back plate attached to the interior side of the trim body with the variable light source disposed between the back plate and the interior side of the trim body.

14. The trim molding of claim 13 wherein the reflective back plate is comprised of a metallization layer on a surface facing the variable light source.

15. The trim molding of claim 1 wherein the trim body is comprised of a clear plastic.

16. The trim molding of claim 15 wherein the trim body includes a recess for receiving the variable light source.

17. A puddle light system for a vehicle, comprising:
a trim body formed of a light transmissive material coupled to the exterior surface, the trim body having an interior side and an exterior side;
a variable light source disposed on the interior side of the trim body;
a one-way mirror disposed on the exterior side of the trim body having an opaque appearance from outside the trim molding in bright ambient lighting conditions, wherein the one-way mirror transmits light from the variable light source therethrough; and
is a driver for activating the variable light source at a first lighting level for accenting the exterior surface of the vehicle in dark ambient lighting conditions, and for activating the variable light source at a second lighting level greater than the first lighting level to illuminate the ground near the vehicle to assist in vehicle entry in dark ambient lighting conditions.

18. The puddle light system of claim 17 wherein the vehicle includes a remote entry system with a wireless key fob, and wherein the driver responds to activation of the wireless key fob by driving the variable light source at the second lighting level.

19. The puddle light system of claim 17 wherein the vehicle includes an exterior running lamp signal, and wherein the driver responds to the exterior running lamp signal by driving the variable light source at the first lighting level.

20. The puddle light system of claim 17 wherein the driver gradually ramps light output up to or down from the second lighting level.

21. Vehicular trim molding comprising:
a light-transmissive body;
a light source within the body; and
a one-way mirror blocking sight into the body and allowing light from the source out of the body;
the light source providing a first lighting level for accenting the exterior surface and providing a second lighting level greater than the first lighting level to illuminate the ground near the vehicle to assist in vehicle entry.
